(19) United States
(12) Patent Application Publication
(10) Pub. No.: US 2025/0105644 A1
(43) Pub. Date: Mar. 27, 2025

(54) METHOD AND SYSTEM FOR BLACKOUT PREVENTION ON A DRILLING RIG

(71) Applicant: Patterson-UTI Drilling Company LLC, Houston, TX (US)

(72) Inventors: Marcel Snijder Van Wissenkerke, Houston, TX (US); Ronald Barbee, Houston, TX (US); Nathaniel Norris, Houston, TX (US); Faramarz Motallebzadeh, Houston, TX (US); Johnathan Eichelman, Houston, TX (US)

(73) Assignee: Patterson-UTI Drilling Company LLC, Houston, TX (US)

(21) Appl. No.: 18/373,646

(22) Filed: Sep. 27, 2023

(51) Int. Cl. H02J 7/00; E21B 44/00; H02J 3/00

(52) U.S. Cl. CPC H02J 7/0068; H02J 3/00; H02J 3/001

(57) ABSTRACT

A method of operating an energy supply system of a drilling rig, the energy supply system including a battery storage, a generator, and an electrical bus that connects to the drilling rig. The method includes: providing power to the electrical bus with the generator or a utility grid (the electrical bus is energized with a bus voltage at a bus frequency); monitoring the electrical bus for a predetermined condition; and controlling an active front end (AFE) connected to the battery storage based on whether or not the predetermined condition is satisfied, such that: a first set of parameters is used by the AFE while the predetermined condition is not satisfied; and a second set of parameters is used by the AFE while the predetermined condition is satisfied.

### BACKGROUND

In the oil and gas industries, a drilling rig is typically powered by one or more generators to provide energy for various operations such as drilling, pumping of drilling mud, tripping or hoisting pipe, and other auxiliary processes. A blackout or unplanned loss of power on a drilling rig can result in downtime with massive impacts on production efficiency and costs of operating the drilling rig. To support the drilling rig during a loss of output from the generators, a battery storage system that can support the drilling rig during a loss of generator-based power supply and/or a utility-based power supply (e.g., a connected utility grid), ideally without interruption of the drilling rig operations, may be desirable.

### SUMMARY

In general, one or more embodiments of the invention relate to a method of operating an energy supply system of a drilling rig, the energy supply system including a battery storage, a generator, and an electrical bus that connects to the drilling rig. The method comprises: providing power to the electrical bus with the generator or a utility grid (the electrical bus is energized with a bus voltage at a bus frequency); monitoring the electrical bus for a predetermined condition; and controlling an active front end (AFE) connected to the battery storage based on whether or not the predetermined condition is satisfied, such that: a first set of parameters is used by the AFE while the predetermined condition is not satisfied; and a second set of parameters is used by the AFE while the predetermined condition is satisfied. In response to detecting the predetermined condition while monitoring the electrical bus, the energy supply system forms a microgrid that powers the drilling rig with only the battery storage (the AFE regulates the microgrid using the second set of parameters). In response to detecting the predetermined condition not being satisfied while monitoring the electrical bus, the energy supply system powers the drilling rig with the generator or the utility grid (the AFE regulates the battery storage using the first set of parameters). The second set of parameters is based on a droop speed control scheme.

In general, one or more embodiments of the invention relate to an energy supply system for operating a drilling rig that includes electrically powered equipment. The energy supply system comprises: an electrical bus that powers the drilling rig; a battery storage configured to draw power from and supply power to the electrical bus; a generator or a utility grid interface configured to supply power to the electrical bus with a bus voltage at a bus frequency; and a processor. The processor is configured to: monitor the electrical bus for a predetermined condition; and control an active front end (AFE) connected to the battery storage based on whether or not the predetermined condition is satisfied, such that: a first set of parameters is used by the AFE while the predetermined condition is not satisfied; and a second set of parameters is used by the AFE while the predetermined condition is satisfied. In response to detecting the predetermined condition while monitoring the electrical bus, the processor is configured to form a microgrid that powers the drilling rig with only the battery storage via the AFE (the AFE regulates the microgrid using the second set of parameters). In response to detecting the predetermined condition not being satisfied while monitoring the electrical bus, the processor is configured to control powering of the drilling rig with the generator or the utility grid interface (the AFE regulates the battery storage using the first set of parameters). The second set of parameters is based on a droop speed control scheme.

In general, one or more embodiments of the invention relate to a non-transitory computer readable medium (CRM) storing computer readable program code for operating an energy supply system of a drilling rig, the energy supply system including a battery storage, a generator, and an electrical bus that connects to the drilling rig. The computer readable program code causes a computer system to: provide power to the electrical bus with the generator or a utility grid (the electrical bus is energized with a bus voltage at a bus frequency); monitor the electrical bus for a predetermined condition; and control an active front end (AFE) connected to the battery storage based on whether or not the predetermined condition is satisfied, such that: a first set of parameters is used by the AFE while the predetermined condition is not satisfied; and a second set of parameters is used by the AFE while the predetermined condition is satisfied. In response to detecting the predetermined condition while monitoring the electrical bus, the energy supply system forms a microgrid that powers the drilling rig with only the battery storage (the AFE regulates the microgrid using the second set of parameters). In response to detecting the predetermined condition not being satisfied while monitoring the electrical bus, the energy supply system powers the drilling rig with the generator or the utility grid (the AFE regulates the battery storage using the first set of parameters). The second set of parameters is based on a droop speed control scheme.

Other aspects of the invention will be apparent from the following description and the appended claims.

### BRIEF DESCRIPTION OF DRAWINGS

FIG. 1 schematically shows a conventional drilling rig configuration equipped with a conventional energy supply system.

FIG. 2 schematically shows a hybrid drilling rig configuration equipped with an energy supply system, in accordance with one or more embodiments.

FIG. 3 shows a schematic of a generator, according to one or more embodiments.

FIGS. 4A-4B show schemes for controlling an active front end of the energy supply system, according to one or more embodiments.

FIGS. 5 shows a flowchart of a method for forming a microgrid that powers the drilling rig with only a battery storage, according to one or more embodiments.

FIGS. 6-8 show flowcharts of methods for switching a set of parameters of the AFE, according to one or more embodiments.

FIG. 9 shows a computer system, in accordance with one or more embodiments.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third) may be used as an adjective for an element (i.e., any noun in the application). The use of ordinal numbers is not to imply or create a particular ordering of the elements nor to limit any element to being only a single element unless expressly disclosed, such as by the use of the terms “before,” “after,” “single,” and other such terminology. Rather the use of ordinal numbers is to distinguish between the elements. By way of an example, a first element is distinct from a second element, and the first element may encompass more than one element and may succeed (or precede) the second element in an ordering of elements.

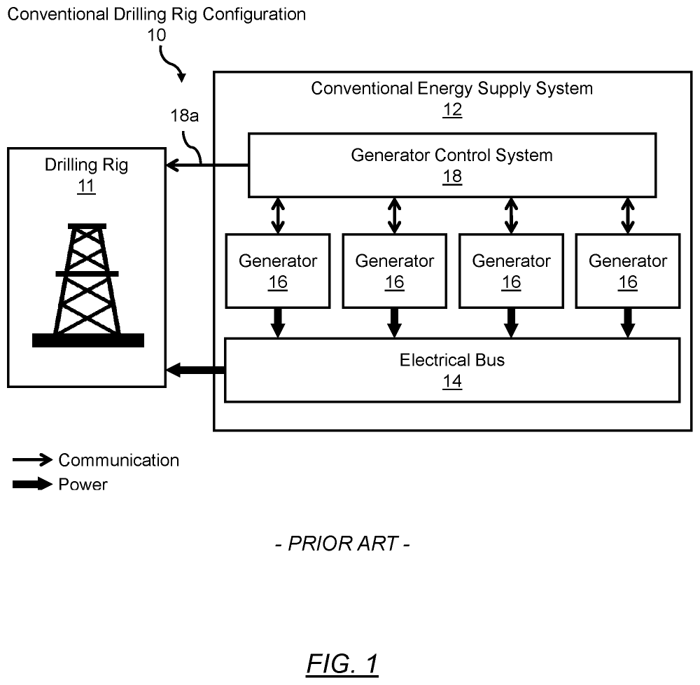

FIG. 1 schematically shows a conventional drilling rig configuration (10).

The conventional drilling rig configuration (10) includes a drilling rig (11), and a conventional energy supply system (12). Each of these components is described in further detail below.

The drilling rig (11) may be any type of drilling rig as it may be used in the oil & gas industries. The drilling rig (11) may include electrically powered equipment such as, for example, a top drive for operating a drill string, one or more mud pumps for pumping of drilling mud, a drawworks for tripping or hoisting pipe, one or more fuel pumps for supplying fuel to generator systems, and/or other auxiliary equipment that generates load demand (e.g., lights, low horsepower motors, etc.).

The electrically powered equipment of the drilling rig (11) receives electrical power from an electrical bus (14) of the conventional energy supply system (12). The electrical bus (14) is powered (i.e., energized) by one or more generators (16) that can each be independently activated/de-activated.

Each generator (16) may include an engine control unit (ECU), a fuel-based engine that produces a braking power (bkW), and a breaker that connects/disconnects the generator (16) from the electrical bus (14). The output of the generator (16) is quantified as a usable electrical power (ekW) that is always lower than the braking power due to parasitic losses (e.g., field losses of the generator, friction and windage losses, using power to drive a radiator fan) and efficiency losses (e.g., incomplete combustion of fuel).

Typically, the number of active (i.e., online) generators (16) is manually controlled by the operators of the drilling rig (11). In other words, the conventional energy supply system (12) does not receive power demand information from the drilling rig (11) and cannot automatically control the number of active generators (16). The operators of the drilling rig (11) must anticipate the power requirements of the active operations and bring a predetermined number of generators (16) online to meet the requirements.

A generator control system (18) controls the one or more generators (16) that are online and connected to the electrical bus (14). The generator control system (18) operates on a closed loop that uses voltage and frequency information from the electrical bus (14) to regulate the throttle setting of the generators (16) and maintain a consistent power profile (e.g., 60 Hz and 600 V) to match the variable load demanded by the drilling rig (11). For example, if a pump on the drilling rig (11) is turned on, the excitation on the generator fields will increase, resulting in an increased load. On the other hand, if rotating equipment slows down, the generators (16) naturally decrease their load. Note that power transmission is unidirectional from the conventional energy supply system (12) to the drilling rig (11). At best, a conventional generator control system (18) may provide a load information (18a) to the drilling rig (11) (i.e., unidirectional communication) such that operators can determine whether generators (16) may need to be activated or deactivated to match demand.

In general, embodiments of the invention provide a method, a system, and a non-transitory computer readable medium (CRM) for preventing and/or mitigating blackout of an energy supply system providing power to a drilling rig. In the event of a generator going offline, the energy supply system prevents a system blackout by forming a microgrid that powers the drilling rig with only a battery storage. As explained in further detail below, the control scheme for an active front end connected to the battery storage is modified (e.g., by changing one or more operational parameters) to regulate the microgrid and switch power supply exclusively to the battery storage without adversely affecting the energy supply system or drilling rig.

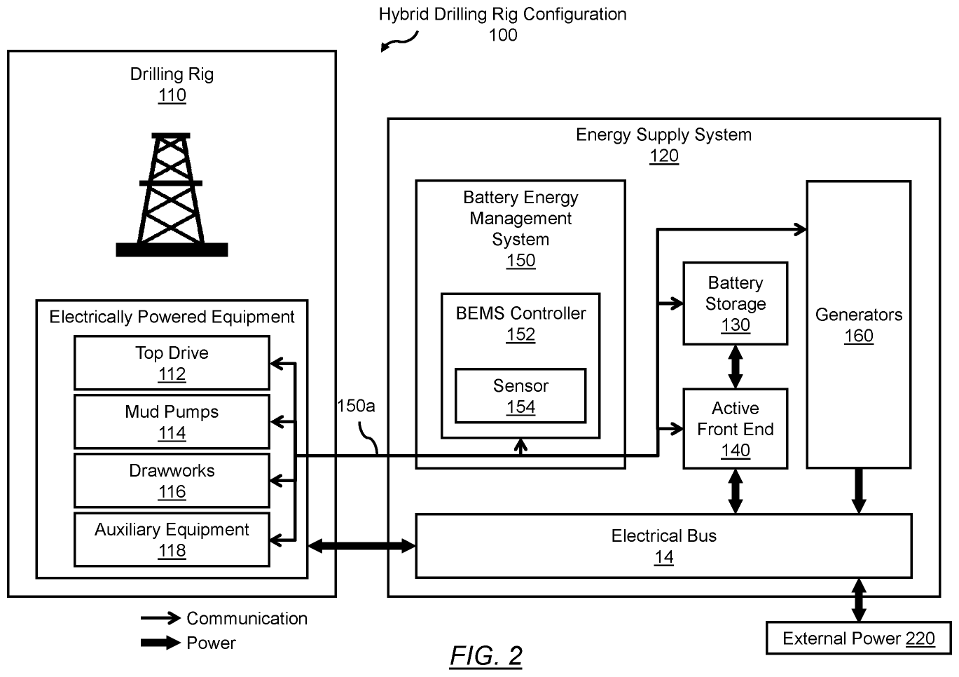

FIG. 2 schematically shows a hybrid drilling rig configuration (100), in accordance with one or more embodiments.

In one or more embodiments, the hybrid drilling rig configuration (100) includes a drilling rig (110), and an energy supply system (120). Each of these components is described in further detail below.

Similar to drilling rig (11), the drilling rig (110) may be any type of drilling rig as it may be used in the oil & gas industries. The drilling rig (110) may include electrically powered equipment such as, for example, a top drive (112) for operating a drill string, one or more mud pumps (114) for pumping of drilling mud, a drawworks (116) for tripping or hoisting pipe, one or more fuel pumps for supplying fuel to generator systems, and/or other auxiliary equipment (118) that generates load demand (e.g., lights, low horsepower motors, etc.).

In one or more embodiments, one or more of the electrically powered equipment (112, 114, 116, 118) installed on the drilling rig (110) may provide data for monitoring activity. For example, the data may include parameters of the equipment (e.g., minimum, maximum, optimal, and/or user defined power levels), real time load information (e.g., streaming time series data), or anticipated load information (e.g., upcoming load estimates, scheduled activation times).

The energy supply system (120) powers the drilling rig (110) with an electrical bus (14). The electrical bus (14) may include a three-phase AC (alternating current) bus with any voltage used by the electrically powered equipment. The electrical bus (14) may further include a DC (direct current) bus with any voltage used by the electrically powered equipment. Any type of electrical bus may be used, without departing from the disclosure. In the energy supply system (120), in addition to interfacing with one or more generators (160), the electrical bus (14) interfaces with a battery storage (130) via an Active Front End (AFE) (140). In one or more embodiments, the electrical bus (14) may be further configured with an additional interface (e.g., a power connection, a power substation, a relay, or any appropriate equipment to receive or exchange power) to connect to an external power supply 220 (e.g., a utility grid, a commercial AC grid).

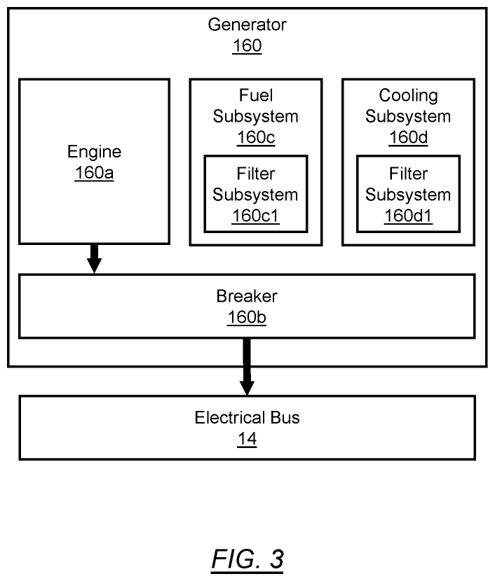

The energy supply system (120) includes one or more generators (160, 160′, . . . ) that can each be independently activated/de-activated. Each generator (160) includes a fuel-based engine of any type (e.g., diesel or natural gas-powered) that produces a braking power (bkW) that is converted into a usable electrical power (ekW). In one or more embodiments, the generator (160) may include an engine control unit (ECU) (not shown) that controls generator (160). Alternatively, the generator (160) may be controlled by another component of the energy supply system (120). While FIG. 2 only shows a single generator (160), any number and/or size may be used. For example, a drilling rig (110) may be equipped with three generators (160, 160′, 160″). Subsystems of a generator (160) are discussed in further detail below with respect to FIG. 3.

The battery storage (130) includes a plurality of battery cells connected in a network (e.g., a plurality of battery cells may be connected in series as a battery pack to achieve a predetermined output voltage level, a plurality of battery cells or battery packs may be connected in parallel to achieve a predetermined current output current level). The battery storage (130) may be configured with any power ratings (e.g., input/output capacity, lifetime, power storage capacity). The battery storage (130) may be of any type that is suitable for repeated charge/discharge cycles. Lithium-ion batteries or other any other appropriate battery chemistry or battery technology may be used.

The battery storage (130) may include additional subsystems (e.g., a battery management system, one or more programmable logic controllers) to monitor and maintain the individual battery cells (e.g., active protection by performing diagnostics based on temperature, voltage, current monitoring). Furthermore, the battery storage (130) may include one or more passive protections (e.g., fuses, breakers, mechanical protections).

The AFE (140) includes one or more bi-directional power inverters that are configured to charge and discharge the battery storage (130) via the electrical bus (14). The AFE (140) may include any type of AC/DC converter. The AFE (140) may support the electrical bus (14) with reactive power, both capacitive and inductive, to provide full control of the exchange between the battery storage (130) and the electrical bus (14). The AFE (140) may have any power ratings (e.g., input/output capacity, volt-ampere rating, apparent power rating). The AFE (140) may mimic the power rating of a generator (160) to use the same connection to the electrical bus (14). Furthermore, the AFE (140) may be equipped with passive and/or active subsystems to maintain the power inverters (e.g., physical enclosures, liquid cooling systems, environmental controls).

While FIG. 2 only shows a single battery storage (130) and a single AFE (140), any number may be used. In one or more embodiments, an energy supply system (120) on a drilling rig (110) may be equipped with three generators (160) that are supported by one battery storage (130) and one AFE (140). The AFE (140) may have similar power ratings as a generator (160), such that the battery storage (130) and AFE (140) take the place of a generator (160), without significant retrofitting. Furthermore, in one or more embodiments, the entire energy supply system (120) may be interchangeable with a conventional energy supply system (12), which typically includes four generators, without significant retrofitting.

The energy supply system (120) further includes a battery energy management system (BEMS) (150) that manages the generators (160), the battery storage (130), and the AFE (140). In one or more embodiments, the BEMS (150) coordinates the flow of energy between the generators (160), the battery storage (130), and the drilling rig (110) to ensure that power is available as needed by the drilling rig (110).

The BEMS (150) coordinates the flow of energy to manage the energy stored in the battery storage (130).

For example, the BEMS (150) may charge the battery storage (130) by connecting it to a generator (160) via the AFE (140) and electrical bus (14). In other words, the BEMS (150) may control the AFE (140) to use the power production capacity of the online generator(s) (160) to charge the battery storage (130). The BEMS (150) may launch an additional generator (160) if the capacity of the battery storage (130) drops below a certain threshold and may shut down one or more generators (160) if the battery capacity approaches a full charge.

In addition, the BEMS (150) may discharge the battery storage (130) to provide supplemental power to electrical bus (14). For example, when demand from the drilling rig (110) exceeds the output capacity of the current number of online generators (160), the BEMS (150) may maintain a steady and optimized load on the current number of online generators (160) and control the AFE (140) to provide a variable amount of supplemental power from the battery storage (130) to meet demand.

In order to perform these and other operations, the BEMS (150) includes a BEMS controller (152). The BEMS controller (152) may be a centralized controller that remotely controls various subsystems of the energy supply system (120). Alternatively, the BEMS controller (152) may be a plurality of distributed controllers (e.g., a collection of coordinated controllers in the AFE (140) and generator (160)) that individually control subsystems of the energy supply system (120) in a synchronized manner.

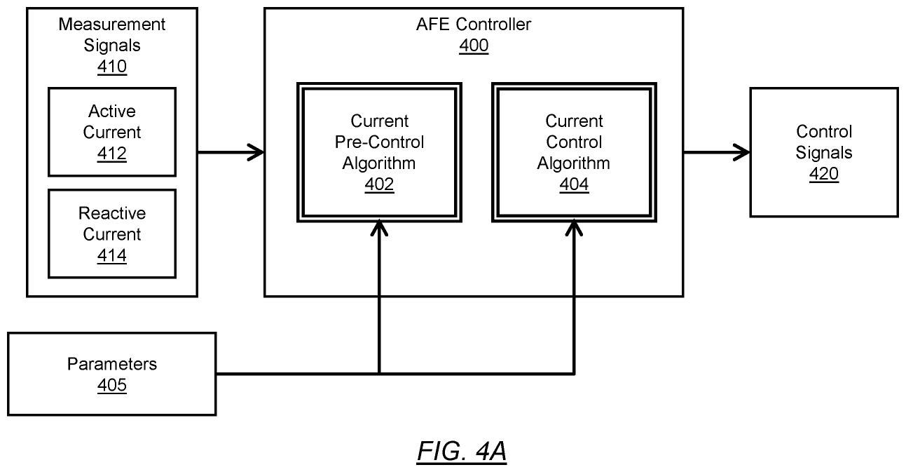

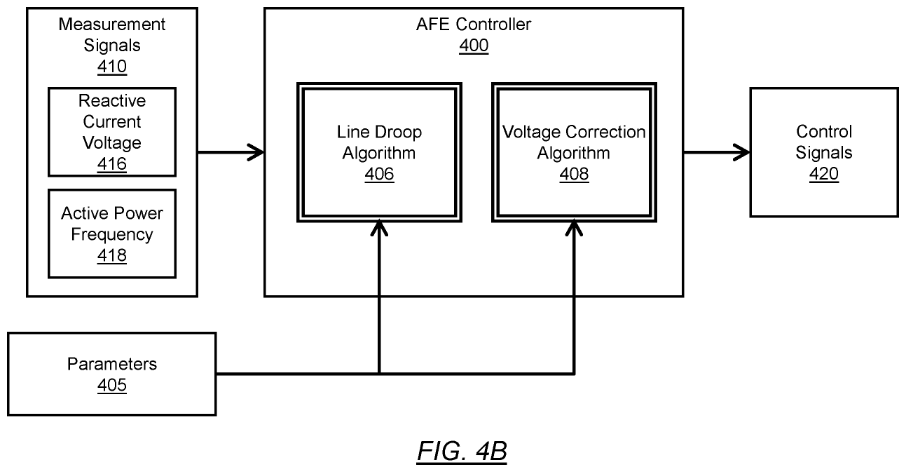

The BEMS controller (152) may include a programmable logic controller (PLC) the governs one or more components of the energy supply system (120). For example, a portion of the PLC may govern the AFE (140) based on multiple different operational modes. For example, the PLC may change the AFE (140) from a grid-following mode (i.e., supporting a generator (160) with the battery storage (130) to maintain voltage and frequency of the electrical bus (14)) to a grid-forming mode (i.e., powering the electrical bus (14) exclusively with the battery storage (130)) by modifying parameters of one or more control schemes implanted by the PLC. Control schemes of the PLC may include one or more controllers (e.g., proportional-integral controller, proportional-derivative controller, proportional-integral-derivative controller, or any appropriate feedback controller) that are modified, as described in further detail with respect to FIGS. 4A-4B, based on the state of the energy supply system (120).

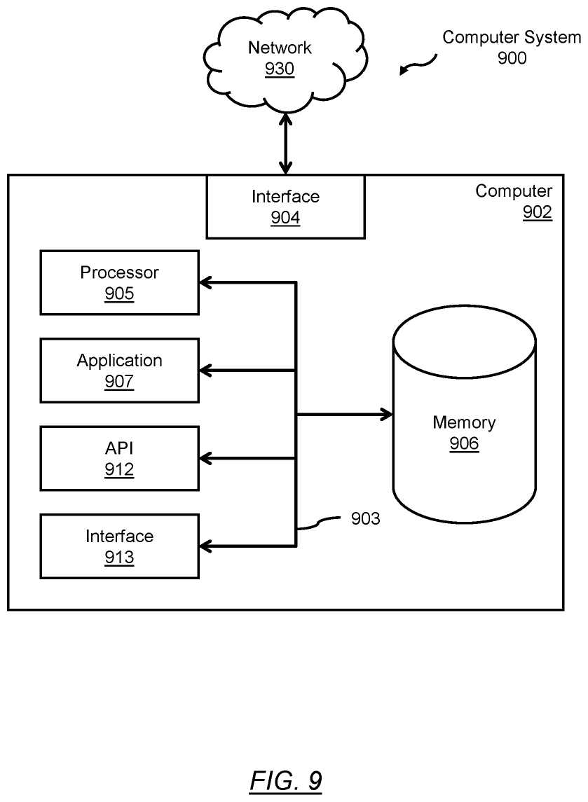

The BEMS controller (152) may be implemented in hardware (i.e., circuitry), software, or any combination thereof. The BEMS controller (152) may include one or more processors or computer systems (e.g., a computer system as described in further detail below with respect to FIG. 9). The computer system may execute instructions for operations based on the flowcharts of FIGS. 4-8.

The BEMS controller (152) may be configured to communicate with the generator(s) (160), the battery storage (130), and the AFE (140) via a network (150a). Furthermore, the BEMS controller (152) may communicate with the drilling rig (110) via the network (150a). The network (150a) may connect to a controller (not shown) on the drilling rig (110) or directly to specific pieces of electrically powered equipment on the drilling rig (110) (e.g., a top drive (112), a mud pump (114), a drawworks (116), and/or a piece of auxiliary equipment (118)). In other words, the BEMS (150) may receive information related to the operations of the drilling rig (110) or the energy supply system (120) (e.g., operational parameters, power demand information, status information, or any other appropriate data) via the network 150a to determine the appropriate instructions and timing for the above described operations of the energy supply system (120).

The network (150a) may be a wired or wireless network (e.g., a local area network (LAN), a wide area network (WAN) such as the Internet, mobile network, or any other type of network) and implemented via one or more network interface connections (e.g., a structural transceiver such as a communication port or antenna) (not shown). The network (150a) may include a variety of communication networks (e.g., CANbus, Modbus, Discrete/Analog inputs) that are integrated with the BEMS controller (152). In one of more embodiments, the BEMS controller (152) may use an Industrial Internet of Things (IIoT) application to access and exchange information from any point of the hybrid drilling rig configuration (100). Data may be streamed online for real-time monitoring by operators and service providers.

In other words, the BEMS controller (152) acts as the central hub of the BEMS (150) and the energy supply system (120). Generally, the BEMS controller (152) is functionally structured as a 2-level system comprising: an upper level that runs machine learning, computes complex optimization strategies, and logs data; and a lower level that enforces operating parameters and executes commands to equipment (e.g., generators (160), battery storage (130), AFE (140)). Examples of parameters used by the BEMS controller (152) are listed in TABLE 1 below. The network (150a) may exchange these parameters, other command information, status information, or any other appropriate data related to the operations of the hybrid drilling rig configuration (100) to and from the BEMS controller (152).

TABLE 1
a. Battery storage (130) and AFE (140)

| | |
|---|---|
| i. | State of charge |
| ii. | Temperatures |
| iii. | AC/DC voltage and currents |
| iv. | Line power monitoring (real and reactive power, power factor, |
| | frequency, AC voltages and currents) |
| v. | Operating status, alarms, faults |

b. Upper level of BEMS controller (152)

| | |
|---|---|
| i. | Forecast of the power required by the drilling rig (110) compared to |
| | energy remaining in the battery storage (130) and performance of the |
| | generator(s) (160) |
| ii. | Start and stop decision monitoring and execution for generator(s) (160) |

c. Lower level of BEMS controller (152)

| i. | Power quality monitoring and remediation (real and reactive power, | |
|---|---|---|
| | power factor, frequency) | |
| ii. | Enforcement of operating parameters | |
| iii. | Communication with controllers (ECU, not shown) of generators (160) | |
| | 1. | AC power values (real and reactive power, power factor, |
| | | frequency, voltage, current) |
| | 2. | Variable frequency drive breaker status for generators (160) |
| | 3. | Operating status, alarms, faults |

d. Engine control unit (ECU) data

| | |
|---|---|
| i. | Fuel consumption (diesel and natural gas substitution) |
| ii. | Engine speed, temperatures, pressures |
| iii. | Throttle position |
| iv. | Engine power |
| v. | Operating status, alarms, faults |

e. Flowmeter data

| | |
|---|---|
| i. | Total diesel flow from fuel tank to generators (160) |
| ii. | Return diesel flow from generators (160) to fuel tank |
| iii. | Total natural gas flow to generators (160) |

In one or more embodiments, the BEMS controller (152) may include (or may be connected to) one or more sensors (154) that measure any of the parameters described in TABLE 1. For example, the sensor (154) may include a power meter, voltmeter, ammeter, flow meter (any phase (e.g., liquid (e.g., oil, fuel), gas (e.g., air, exhaust))), clog detector, temperature sensor (e.g., thermocouple, thermometer), pressure sensor, failure sensor (e.g., mechanical failure, blown gasket sensor), fill gauge, or any appropriate equipment to determine one or more of the parameters described in TABLE 1. In one or more embodiments, the sensor (154) may be incorporated into component of the energy supply system (120) (e.g., on the generator (160), in a subsystem of the generator (160) (e.g., described below with respect to FIG. 3), on the electrical bus (14)).

In one or more embodiments, the BEMS controller (152) and/or sensor (154) may be configured to detect one or more of the following: low fuel pressure, a clogged air filter, high temperature, low coolant, mechanical issues, clogged fuel filters, clogged air filters, clogged oil filters, high coolant or oil temperature, loss of fuel pressure (fuel pumps), mechanical issue with generator (e.g., clogged fuel injector, blown gasket).

While FIG. 2 shows various configurations of hardware components and/or software components, other configurations may be used without departing from the scope of the disclosure. For example, the energy supply system (120) may include additional components such as transformers, switchboards, switchgear, etc. Further, various components in FIG. 2 may be combined to create a single component. In addition, the functionality of each component described above may be shared among multiple components or performed by a different component than that described above. In addition, each component may be utilized multiple times (e.g., in serial, in parallel, distributed locally or remotely) to perform the functionality of the claimed invention.

FIG. 3 shows a schematic of the generator (160), according to one or more embodiments.

As discussed above, each generator (160) includes an engine (160a) to produce usable electrical power (ekW) and a breaker (160b) that connects/disconnects the generator (160) from the electrical bus (14). The engine (160a) is supported by a fuel subsystem (160c) that supplies the engine (160a) and a cooling subsystem (160d) that regulates the engine (160a).

The fuel subsystem (160c) may include a fuel pump and fuel injector that supply the engine (160a) with fuel from a storage system. In addition, the fuel subsystem (160c) may supply oil (e.g., via an oil pump) to the engine (160a). Furthermore, the fuel subsystem (160c) may include a filter subsystem (160c1) that filters the fuel and oil supplied to the engine (160a).

Furthermore, the fuel subsystem (160c) may include one or more sensors (154). For example, the one or more sensors (154) may monitor the fuel pump, the fuel injector, the oil pump, a fuel filter, an oil filter, storage amounts of fuel and/or oil, flow rates of fuel and/or oil, pressure levels of fuel and/or oil, fuel and/or oil temperatures, or any mechanical issues (e.g., broken components, blown seals, etc.). Each sensor (154) may measure one or more parameters described in TABLE 1 (e.g., fuel consumption (diesel and natural gas substitution, total diesel flow from fuel tank to generators (160), return diesel flow from generators (160) to fuel tank, total natural gas flow to generators (160)).

Each sensor (154) may indicate a fault has occurred in the fuel system (160c) in response to a measured value failing to satisfy a predetermined condition (e.g., a nominal operational range or setpoint). Measurement information and/or status information regarding any component of the fuel system (160c) may be provided to the engine control unit, BEMS (150) (e.g., via network (150a)), and/or any other system that controls the generator (160).

The coolant system (160d) may include a coolant pump that supplies the engine (160a) with coolant from a reservoir. In addition, the coolant system (160c) may include one or more fans to cool the engine (160a) and remove exhaust from the engine (160a). Furthermore, the coolant system (160d) may include a filter subsystem (160d1) that filters the coolant.

Furthermore, the coolant system (160d) may include one or more sensors (154). For example, the one or more sensors (154) may monitor the coolant pump, the fan(s), a coolant filter, an air filter, an exhaust filter, a storage amount of coolant, a flow rate of the coolant, a pressure of coolant, a coolant temperature, or any mechanical issues (e.g., broken components, blown seals, etc.). Each sensor (154) may measure one or more parameters described in TABLE 1 (e.g., Engine speed, temperatures, pressures) or any other parameter related to the cooling system (160d) (e.g., temperatures, pressures, flow rates of liquids (e.g., coolant) or gas (e.g., air, exhaust), clogging in a filter).

Each sensor (154) may indicate a fault has occurred in the coolant system (160d) in response to a measured value failing to satisfy a predetermined condition (e.g., a nominal operational range or setpoint). Measurement information and/or status information regarding any component of the coolant system (160d) may be provided to the engine control unit, BEMS (150) (e.g., via network (150a)), and/or any other system that controls the generator (160).

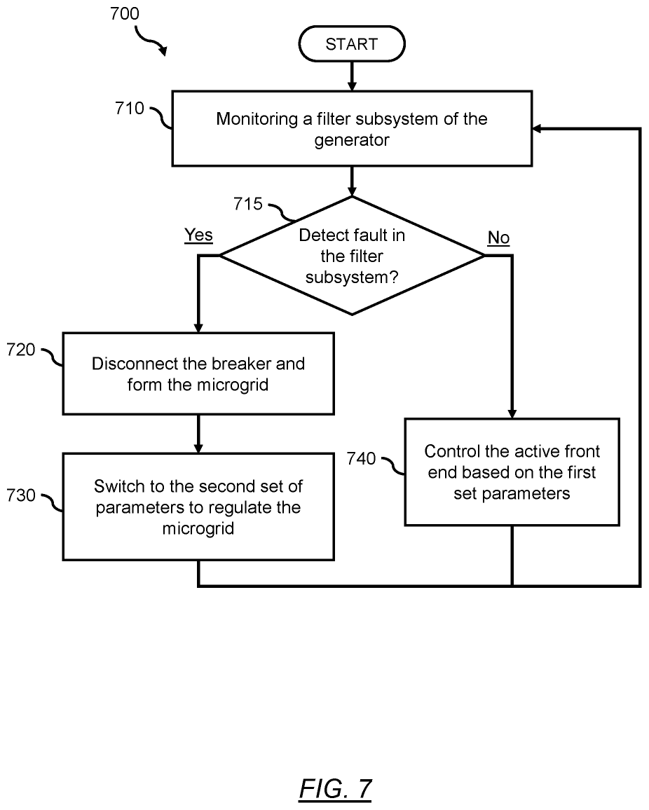

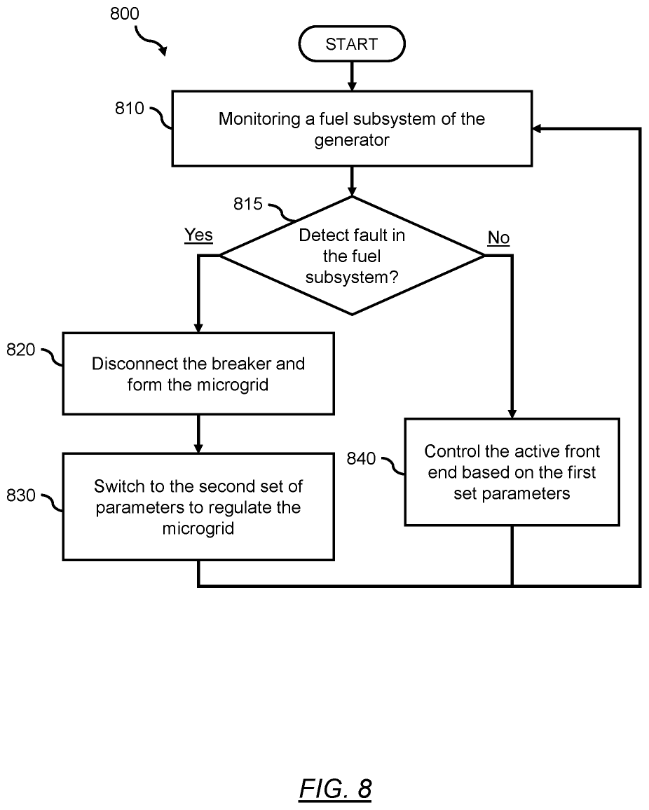

As explained in further detail below with respect to FIGS. 7-8, the subsystems of the generator (160) may be monitored to trigger changes in the control scheme of the AFE (140) and improve blackout prevention/management in the hybrid drilling rig configuration (100).

While FIG. 3 shows an example configuration of the generator (160), other configurations may be used without departing from the scope of the disclosure. For example, the breaker (160b) may be independent from the generator (160). Furthermore, the generator (160) may include additional components such as transformers, switchboards, switching gear, etc. Further, various components in FIG. 3 may be combined to create a single component. In addition, the functionality of each component described above may be shared among multiple components or performed by a different component than that described above.

### Non-limiting Examples of an Energy Supply System

In one or more embodiments, the battery storage (130) includes lithium-ion batteries configured with protection and monitoring technology. The battery racks of the battery storage (130) may be packaged in any appropriate facility (e.g., in a climate-controlled building or appropriate container) and set on location next to three diesel generators (160), each configured to provide one megawatt (MW) of power. The AFE (140) includes an AC/DC converter. With approximately 3 MW of power available from the three diesel generators (160) and of the additional discharge capacity available from battery storage (130), an energy supply system (120) according to one or more embodiments may handle the most demanding drilling conditions of a drilling rig (110), while reducing fuel consumption and improving emissions by reducing runtime of the generators (160).

In the following description, the above configuration may be used as a non-limiting example of an energy supply system in accordance with embodiments of the invention to describe some of the basic possible operating modes. Although the following disclosure is described with respect to the above configuration, those skilled in the art, having benefit of this disclosure, will appreciate that various other embodiments may be devised without departing from the scope of the present invention.

### Example Operations

As explained in further detail below with respect to FIGS. 4-8, embodiments of the invention include, in response to the breaker (160b) disconnecting the generator (160) from the electrical bus (14), switching one or more parameters of the AFE (140) to form a microgrid that powers the drilling rig (110) with only the battery storage (130) via the AFE (140). In other words, embodiments of the invention include seamlessly switching from a grid-following mode to a grid-forming mode that maintains a predetermined voltage (e.g., 600V) and predetermined frequency (e.g., 60 Hz) to keep the drilling rig (110) powered without interruption.

Control of the AFE (140) may be based on monitoring different aspects of the energy supply system (120) (e.g., monitoring the breaker (160b) directly, monitoring the generator (160) and/or generator subsystems (e.g., fuel system (160c), coolant system (160d), monitoring the electrical bus (14)). For example, control parameters of the AFE (140) may be changed based on a change in state of the fuel pump, the fuel injector, the oil pump, a fuel filter, an oil filter, storage amounts of fuel and/or oil, flow rates of fuel and/or oil, pressure levels of fuel and/or oil, fuel and/or oil temperatures, mechanical issues (e.g., broken components, blown seals, etc.), or an operational status of one or more generator subsystems (160c, 160d).

FIGS. 4A-4B show schemes for controlling the AFE (140) of the energy supply system (120), according to one or more embodiments.

An AFE controller (400) is hardware (e.g., circuitry), software, or a combination of hardware and software that controls the operations of the AFE (140). In one or more embodiments, the AFE controller (400) may include a programmable logic controller (PLC). The PLC may be integrated in the AFE (140) or, alternatively, the BEMS controller (152) may include the PLC to control the AFE (140) via the network (150a).

In FIG. 4A, the AFE controller (400) is configured to execute a control scheme for a grid-following mode of the AFE (140). As discussed above, in the grid-following mode, a generator (160) is online and connected to the electrical bus (14) to supply power to the drilling rig (110) while the AFE (140) supports the generator (160) with the battery storage (130). For example, if additional equipment on the drilling rig (110) is activated to suddenly increase the power demand beyond the rating of the connected generator (160), the AFE (140) supports the load spikes from the drilling rig (110) with output from the battery storage (130).

In grid-following mode, also referred to as “current control” mode, the AFE controller (400) accepts measurement signals (410) as inputs into one or more algorithms that output control signals (420).

Measurement signals (410) may include AC/DC measurement values such as an active current signal (412), a reactive current signal (414), or a signal for any other appropriate parameter from above TABLE 1.

The grid-following control scheme implemented by the AFE controller (400) includes: a current pre-control algorithm (402); and a current control algorithm (404). The active current signal (412) and the reactive current signal (414) are input into the current pre-control algorithm (402). In one or more embodiments, the output signals of the current pre-control algorithm (402) and/or the original active current signal (412) and the original reactive current signal (414) are input into the current control algorithm (404).

Each of the algorithms (402, 404) of the AFE controller (400) includes signal processing mechanisms (e.g., filtering, scaling, integrating, differentiating, proportional-integral controller, proportional-derivative controller, proportional-integral-derivative controller, or any appropriate feedback controller) based on one or more parameters (405) (e.g., coefficients, setpoints, upper/lower limits, ranges). In grid-following mode, the AFE controller (400) utilizes a first set of parameters (405) to control the AFE (140) while the generator (160) is connected to the electrical bus (14). The first set of parameters (405) may include one or more of the following: filter selections, filter parameters, filter compensation parameters, scaling coefficients, time constants, and/or control set points.

The output signals from the current control algorithm (404) or the output of the programmed algorithms of the AFE controller (400) result in control signals (420) that control and/or regulate operations of the AFE (140). The control signals (420) include one or more signals, values, and/or commands to regulate the AFE (140) to maintain voltage and frequency of the electrical bus (14)) while supporting the online generator (160).

In FIG. 4B, the AFE controller (400) is configured to execute a control scheme for a grid-forming mode of the AFE (140). As discussed above, in the grid-forming mode, the generator (160) is disconnected from the electrical bus (14), which is powered exclusively with the battery storage (130) via the AFE (140). For example, when the breaker (160b) trips and the generator (160) is disconnected from the electrical bus (14), the energy supply system (120) forms a microgrid to power the drilling rig (110) with only the battery storage (13) via the AFE (140). In other words, the AFE (140) mimics the power rating of the generator (160) to maintain the same voltage and frequency on the electrical bus (14) while the generator (160) is offline.

In grid-forming mode, also referred to as “voltage droop active” mode, the AFE controller (400) accepts the measurement signals (410) as inputs into one or more algorithms, different from the algorithms of the grid-following mode, that output control signals (420). In this more, the measurement signals (410) may include AC/DC measurement values such as a reactive current voltage (416), an active power frequency signal (418), or a signal for any other appropriate parameter from above TABLE 1.

The grid-forming control scheme implemented by the AFE controller (400) includes: a line droop algorithm (406); and a voltage correction algorithm (408). The reactive current voltage (416) and the active power frequency signal (418) are input into the line droop algorithm (406). In one or more embodiments, the output signals of the line droop algorithm (406) are input into the voltage correction algorithm (408).

Each of the algorithms (406, 408) of the AFE controller (400) includes signal processing mechanisms (e.g., filtering, scaling, integrating, differentiating, proportional-integral controller, proportional-derivative controller, proportional-integral-derivative controller, or any appropriate feedback controller) based on one or more parameters (405) (e.g., coefficients, setpoints, upper/lower limits, ranges). In grid-forming mode, the AFE controller (400) utilizes a second set of parameters (405), different from the first set of parameters in the grid-following mode, to control the AFE (140) while the generator (160) is disconnected to the electrical bus (14). The second set of parameters (405) may include one or more of the following: frequency droop gradient, frequency droop smoothing time, voltage droop gradient, voltage droop smoothing time, voltage control proportional gain, voltage control integration time, filter selections, filter parameters, scaling coefficients, time constants, and/or control set points.

The output signals from the voltage correction algorithm (408) or the output of the programmed algorithms of the AFE controller (400) result in control signals (420) that control and/or regulate operations of the AFE (140). The control signals (420) include one or more signals, values, and/or commands to regulate the AFE (140) to regulate the microgrid while the generator (160) disconnected.

While the above embodiments are described with respect to a control scheme based on droop speed control, those skilled in the art, having benefit of this disclosure, will appreciate that various other embodiments (e.g., control schemes with corresponding sets of parameters (405)) may be devised without departing from the scope of the present invention.

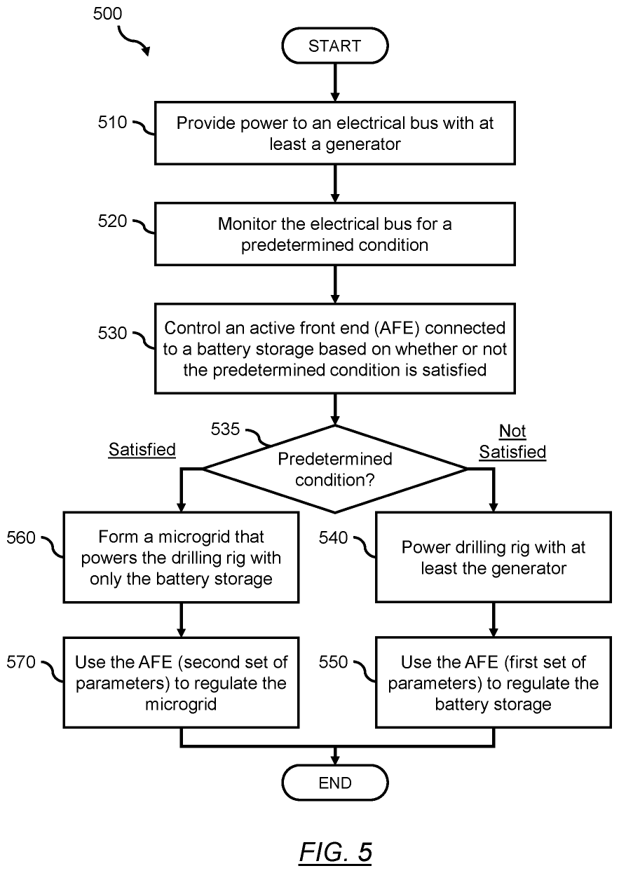

FIG. 5 shows a flowchart of a method (500) for forming a microgrid that powers the drilling rig (110) with only a battery storage (130), according to one or more embodiments.

At 510, the energy supply system (120) provides power to the electrical bus (14) with at least one or more generators (160). Each of the one or more generators (160) are connected to the electrical bus (14) by a corresponding breaker (160b) and energize the electrical bus (14). For example, a bus voltage of 600 V and a bus frequency of 60 Hz may be used to energize the electrical bus (14) and provide power to the drilling rig (110). The bus voltage and the bus frequency may be any appropriate value based on the configuration of the hybrid drilling rig configuration (100) and/or the usage case.

In one or more embodiments, the bus voltage and the bus frequency may be based on or determined by parameters described in TABLE 1. In one or more embodiments, the bus voltage and the bus frequency may be determined by obtaining information from the drilling rig (110).

At 520, the energy supply system (120) monitors the electrical bus (14) for a predetermined condition. The energy supply system (120) may monitor and/or record the bus voltage and the bus frequency via one or more sensors (154) (e.g., a power meter, ammeter, and/or voltmeter). In one or more embodiments, the energy supply system (120) may monitor and/or record a connection status of each breaker (160b) of the one or more generators (160). In one or more embodiments, the energy supply system (120) may monitor and/or record a fault status for one or more subsystems of the one or more generators (160). The monitoring may include real time measurements or measurements over a period of time (i.e., time series data).

The predetermined condition may include at least one of the following: a breaker (160b) entering or being in a disconnected state (i.e., a generator (160) is disconnected from the electrical bus (14) for any reason); a fault detected in one or more subsystem(s) of the generator(s) (160); and the bus frequency of the electrical bus (14) being outside a predetermined range (e.g., due to problems with a generator (160) and/or an external power supply (220)). In other words, the predetermined condition may be defined as one or more conditions under which power supply to the drilling rig (110) is expected to fall below operational standards (e.g., stop, desynchronize, interrupt).

The following are non-limiting examples of conditions that may cause the predetermined condition to be satisfied: a breaker (160b) receives a command to disconnect a generator (160); the bus frequency is measured outside a predetermined range (e.g., exceeding a threshold offset value from the nominal operating frequency); the bus voltage is measured outside a predetermined range (e.g., exceeding a threshold offset value from the nominal operating voltage); fault (e.g., temperature, pressure, flow, filter, output, runtime, wear limits outside of predetermined ranges) or failure (e.g., mechanical, electrical, communications) of any subsystem (e.g., the engine (160a), the breaker (160b), the fuel subsystem (160c), cooling subsystem (160d), filter subsystem(s) (160c1, 160d1)) of a generator (160); fault or failure of an external power supply (220) (e.g., utility grid outage). Each of the above conditions may be monitored by an appropriate sensor (154) of the energy supply system (120). Non-limiting examples in accordance with one or more embodiments are described in more detail below with respect to FIG. 7-8.

Those skilled in the art, having benefit of this disclosure, will appreciate that various other embodiments may be devised without departing from the scope of the present invention. For example, other faults in the energy supply system (120) may also satisfy the predetermined condition in accordance with the scope of the invention.

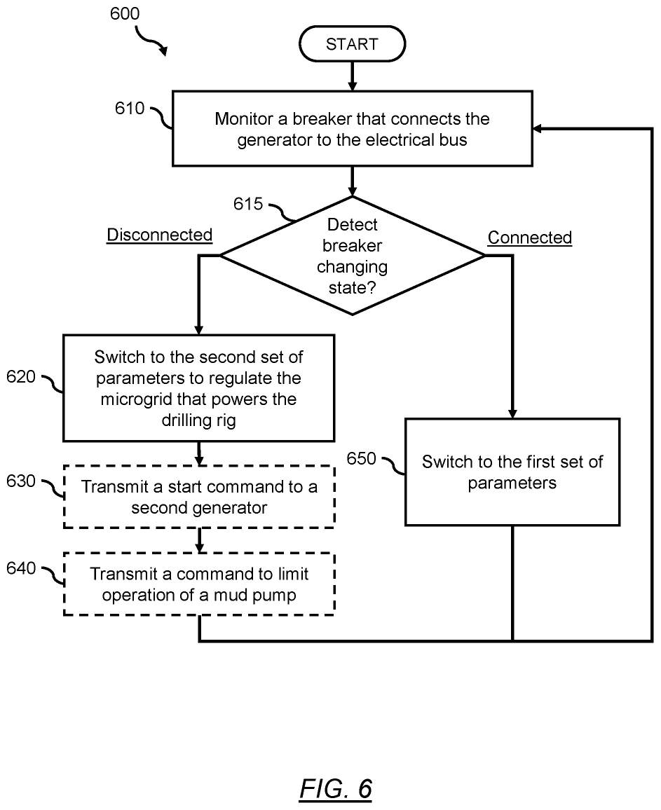

By monitoring the electrical bus (14), breaker(s) (160b), and/or subsystem(s) of the generator(s) (160) for the predetermined condition, the energy supply system (120) may more quickly respond to changes in operation of the hybrid drilling rig configuration (100). In one or more embodiments, the energy supply system (120) may respond to changes in the bus voltage and/or bus frequency caused by faults in the hybrid drilling rig configuration (100) (e.g., breakers disconnecting generators, operational changes in fuel pumps, drilling rig equipment), as described in further detail below with respect to FIGS. 6-8.

At 530, the energy supply system (120) controls the AFE (140) based on whether or not the predetermined condition is satisfied.

Therefore, at 535, the energy supply system (120) determined whether or not the predetermined condition is satisfied.

When the determination at 535 is that the predetermined condition is not satisfied, the process continues to 540.

At 540, the energy supply system (120) provides power to the drilling rig (110) with at least one generator (160). In one or more embodiments, the drilling rig (110) may be powered by a combination of the at least one generator (160), the battery storage (130), and the external power source (220) (e.g., a utility grid).

At 550, the energy supply system (120) uses the AFE (140) to regulate the battery storage (130) (e.g., control input and output from the battery storage (130)). As discussed above, when the electrical bus (14) is powered by one or more generators (160), the AFE (140) operates in a “grid-following”/“current control” mode. In this mode, the energy supply system (120) uses a first set of parameters to control how quickly the AFE (140) will move to a new command current setpoint.

For example, the AFE (140) may execute multiple control stages (e.g., separate, but related, current pre-control and current control stages) that regulate the output of the battery storage (130) into the electrical bus (14) based on the first set of parameters. In other words, after the initial build-up of the DC-side voltage, the AFE (140) is controlled to either export or import real power (kW) based on the setpoints included in the first set of parameters (e.g., provided by a PLC, the AFE controller (400), and/or the BEMS controller (152)).

In one or more embodiments, the first set of parameters may include predefined values for one or more proportional-integral (PI) controllers of the AFE (140) (e.g., PI control stage in the AFE controller (400)). The one or more PI controllers of the AFE (140) may include any of a proportional-integral controller, a proportional-integral-derivative controller, or any appropriate feedback controller. The reaction time and stability of the control loop is governed by the first set of parameters.

When the determination at 535 is that the predetermined condition is satisfied, the process continues to 550.

At 560, the energy supply system (120) forms a microgrid that powers the drilling rig (110) with only the battery storage (130). At 560, the energy supply system (120) uses the AFE (140) to regulate the microgrid. In other words, when the electrical bus (14) is powered by only the battery storage (130), the AFE (140) operates in a “grid-forming”/“voltage droop active” mode. In this mode, energy supply system (120) uses a second set of parameters to manage the reaction of the AFE (140) to loading on the electrical bus (14). In one or more embodiments, the second set of parameters (405) may include set points for one or more proportional integral (PI) controllers of the AFE (140) (e.g., PI control stage in the AFE controller (400)) that are different from the first set of parameters (405).

In one or more embodiments, the second set of parameters (405) may include PI controller set points for a frequency droop gradient and a voltage droop gradient of the microgrid. In one or more embodiments, the second set of parameters (405) includes PI controller set points for a frequency droop smoothing time and a voltage droop smoothing time of the microgrid.

Alternatively, in one or more embodiments, the second set of parameters (405) may include PI controller set points for a frequency droop gradient and a frequency droop smoothing time of the microgrid. In one or more embodiments, the second set of parameters (405) includes PI controller set points for a voltage droop gradient and a voltage droop smoothing time of the microgrid.

The seamless switching from the grid-following mode to the grid-forming mode requires critical timing and calibration. In other words, in one or more embodiments, the first set and second set of parameters are result-effective variables in the control of the AFE (140). Furthermore, the switch between the generators (160) and the battery storage (130) must be controlled within a critical timing window (e.g., under 30 milliseconds, under 2 AC cycles), during which the AFE (140) regulates the electrical bus (14).

By implementing blackout prevention using method (500) to control the AFE (140), an energy supply system (120) can effectively mitigate or prevent interruptions in the power supply to the drilling rig (110). For example, switching the parameters of the AFE (140) based on method (500) can prevent damage to equipment and/or significantly operational delay caused by breakers triggering in electrically powered equipment on the drilling rig (110).

FIGS. 6-8 show flowcharts of methods for switching a set of parameters (405) of the AFE (140), according to one or more embodiments.

In accordance with one or more embodiments, the flowchart of FIG. 6 shows a method (600) for switching a set of parameters (405) of the AFE (140) based on a state of a breaker (160b) of a generator (160).

At 610, the energy supply system (120) monitors a breaker (160b) that connects the generator (160) to the electrical bus (14). For example, a sensor (154) may be connected to the breaker (160b) to determine whether or not the generator (160) is electrically connected to the electrical bus (14). Alternative, the generator (160) may include a controller (e.g., an ECU) that monitors and reports connection status information to another controller of the energy supply system (120) (e.g., the BEMS controller (152), a PLC in the AFE (140), any appropriate processor/control system of the energy supply system (120)).

At 615, the energy supply system (120) detects a change in the state of the breaker (160b).

When the determination at 615 is that the breaker (160b) is disconnected, the process continues to 620.

At 620, the energy supply system (120) switches to the second set of parameters to regulate the microgrid that powers the drilling rig (110) with only the battery storage (130). The AFE (140) is controlled using the second set of parameters under a grid-forming control scheme in accordance with FIG. 4B.

Optionally, at 630, the energy supply system (120) may transmit a start command to a secondary generator (160′). In one or more embodiments where the energy supply system (120) includes a plurality of generators (160, 160′, . . . ), the energy supply system (120) may prioritize restoring generator-based power supply after preventing a blackout with the battery-based power supply. In other words, to achieve a faster restoration of generator-based power supply, the energy supply system (120) begins the process of starting, synchronizing, and connecting a secondary generator (160′) to the electrical bus (14) to replace the disconnected generator (160).

Optionally, at 640, the energy supply system (120) may transmit a command to limit operation of any of the following: a mud pump (114), a top drive (112), a drawworks (116), or any auxiliary equipment (118) on the drilling rig (110). The command may include any combination of parameters described in TABLE 1.

For example, the command may limit an amount of power or a duration of power supplied to a mud pump (114). In one or more embodiments, the command may limit an operational parameter (e.g., a maximum ramp rate or a maximum acceleration rate is lowered). In one or more embodiments, the command may change a parameter setpoint (e.g., a ramp rate setpoint, a speed setpoint, an acceleration setpoint, a duration setpoint, a horsepower setpoint). A setpoint may be a minimum value, a default value, or a maximum value for a given parameter. In other words, the energy supply system (120) may limit the performance of one or more aspects of the mud pump (114) to ensure that the power demand does not overload the battery storage (130) or drain the battery storage (130) too quickly.

Although 640 has been described with respect to a limiting operation of a mud pump (114), those skilled in the art, having benefit of this disclosure, will appreciate that various other embodiments may be devised without departing from the scope of the present invention. For example, the energy supply system (120) may transmit a command to the top drive (112), the drawworks (116), or any other electrically powered system on the drilling rig (110) that can be limited.

When the determination at 615 is that the breaker (160b) is connected, the process continues to 650.

At 650, the energy supply system (120) switches to the first set of parameters. The AFE (140) is controlled using the first set of parameters under a grid-following control scheme in accordance with FIG. 4A.

After 640 or 650, the process may end or may return to 610 (e.g., continuous monitoring of the breaker (160b).

In accordance with one or more embodiments, the flowchart of FIG. 7 shows a method (700) for switching a set of parameters (405) of the AFE (140) based on a detecting a fault in a filter subsystem (160c1, 160d1) of the generator (160).

At 710, the energy supply system (120) monitors a filter subsystem (160c1, 160d1) of the generator (160). For example, one or more sensors (154) (e.g., liquid (e.g., oil, fuel) or gas (e.g., air, exhaust) flow meter, clog detector, temperature sensor (e.g., thermocouple, thermometer), pressure sensor, failure sensor (e.g., mechanical failure, blown gasket sensor), fill gauge, or any appropriate equipment to determine one or more of the parameters described in TABLE 1) may be connected to one or more of the filter subsystem (160c1) in the fuel subsystem (160c) and the filter subsystem (160d1) in the cooling subsystem (160d) to detect a fault (e.g., clogged filter, high temperature, abnormal flow rate, abnormal pressure, or mechanical issue in the subsystems that manage air/fuel/oil/coolant/exhaust).

At 715, the energy supply system (120) determines whether or not a fault is detected a fault in the filter subsystem(s) (160c1, 160d1).

When the determination at 715 is YES (i.e., a fault in the filter subsystem(s) (160c1, 160d1)), the process continues to 720. In one or more embodiments, the YES determination at 715 indicates that the predetermined condition has been satisfied.

At 720, the energy supply system (120) disconnects the breaker (160b) and form the microgrid. In other words, by monitoring one or more of the filter subsystem(s) (160c1, 160d1), the energy supply system (120) can switch away from generator-based power supply before an unplanned shutdown occurs. With a controlled disconnection of the breaker (160b) and planned formation of the microgrid, blackouts in the hybrid drilling rig configuration (100) are prevented.

At 730, the energy supply system (120) switches to the second set of parameters to regulate the microgrid. The AFE (140) is controlled using the second set of parameters under a grid-forming control scheme in accordance with FIG. 4B. Similar to the preemptive disconnection of the breaker (160b) at 720, the energy supply system (120) can improve blackout prevention with a controlled and coordinated switching of the control scheme of the AFE (140).

When the determination at 715 is that NO (i.e., no fault in the filter subsystem(s) (160c1, 160d1)), the process continues to 740.

At 740, the energy supply system (120) controls the AFE (140) based on the first set parameters. In other words, the AFE (140) is controlled using the first set of parameters under a grid-following control scheme in accordance with FIG. 4A.

After 730 or 740, the process may end or may return to 710 (e.g., continuous monitoring of the filter subsystem(s) (160c1, 160d1).

In accordance with one or more embodiments, the flowchart of FIG. 8 shows a method (800) for switching a set of parameters (405) of the AFE (140) based on detecting a fault in a fuel subsystem (160c) of the generator (160).

At 810, the energy supply system (120) monitors a fuel subsystem (160c) of the generator (160). For example, one or more sensors (154) (e.g., liquid (e.g., oil, fuel) or gas (e.g., air, exhaust) flow meter, clog detector, temperature sensor (e.g., thermocouple, thermometer), pressure sensor, failure sensor (e.g., mechanical failure, blown gasket sensor), fill gauge, or any appropriate equipment to determine one or more of the parameters described in TABLE 1) may be connected to the fuel subsystem (160c) to detect a fault (e.g., clogged fuel/oil line, high oil temperature, abnormal fuel/oil flow rate, abnormal fuel/oil pressure, or mechanical issue).

At 815, the energy supply system (120) determines whether or not a fault is detected in the fuel subsystem (160c).

When the determination at 815 is YES (i.e., a fault in the fuel subsystem (160c)), the process continues to 820. In one or more embodiments, the YES determination at 815 indicates that the predetermined condition has been satisfied.

At 820, the energy supply system (120) disconnects the breaker (160b) and form the microgrid. In other words, by monitoring the fuel subsystem (160c), the energy supply system (120) can switch away from generator-based power supply before an unplanned shutdown occurs. With a controlled disconnection of the breaker (160b) and planned formation of the microgrid, blackouts in the hybrid drilling rig configuration (100) are prevented.

At 830, the energy supply system (120) switches to the second set of parameters to regulate the microgrid. The AFE (140) is controlled using the second set of parameters under a grid-forming control scheme in accordance with FIG. 4B. Similar to the preemptive disconnection of the breaker (160b) at 820, the energy supply system (120) can improve blackout prevention with a controlled and coordinated switching of the control scheme of the AFE (140).

When the determination at 815 is that NO (i.e., no fault in the fuel subsystem (160c)), the process continues to 840.

At 840, the energy supply system (120) controls the AFE (140) based on the first set parameters. In other words, the AFE (140) is controlled using the first set of parameters under a grid-following control scheme in accordance with FIG. 4A.

After 830 or 840, the process may end or may return to 810 (e.g., continuous monitoring of the fuel subsystem (160c).

Although FIG. 8 has been described with respect to a limited number of examples directed to a fault in a fuel subsystem (160c), those skilled in the art, having benefit of this disclosure, will appreciate that various other embodiments may be devised without departing from the scope of the present invention. For example, the method (600) may similarly be applied to a fault in the cooling subsystem (160d) or any other subsystem of the generator (160).

While the various steps in FIGS. 5-8 are presented and described sequentially, one of ordinary skill in the art will appreciate that some or all of the blocks may be executed in different orders, may be combined, or omitted, and some or all of the blocks may be executed in parallel. Furthermore, the blocks may be performed actively or passively. The methods of FIGS. 5-8 may be implemented using instructions stored on a non-transitory medium that may be executed by a controller, a processor (e.g., a PLC), or a computer system, as discussed in further detail below with respect to FIG. 9.

FIG. 9 shows a computing system, according to one or more embodiments. Embodiments may be implemented on a computer system. FIG. 9 is a block diagram of a computer system (900) used to provide computational functionalities associated with described algorithms, methods, functions, processes, flows, and procedures as described in the instant disclosure, according to an implementation. The illustrated computer (902) is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (902) may include a computer that includes an input device, such as a keypad, keyboard, touch screen, or other device that can accept user information, and an output device that conveys information associated with the operation of the computer (902), including digital data, visual, or audio information (or a combination of information), or a GUI.

The computer (902) can serve in a role as a client, network component, a server, a database or other persistency, or any other component (or a combination of roles) of a computer system for performing the subject matter described in the instant disclosure. The illustrated computer (902) is communicably coupled with a network (930). In some implementations, one or more components of the computer (902) may be configured to operate within environments, including cloud-computing-based, local, global, or other environment (or a combination of environments).

At a high level, the computer (902) is an electronic computing device operable to receive, transmit, process, store, or manage data and information associated with the described subject matter. According to some implementations, the computer (902) may also include or be communicably coupled with an application server, e-mail server, web server, caching server, streaming data server, business intelligence (BI) server, or other server (or a combination of servers).

The computer (902) can receive requests over network (930) from a client application (for example, executing on another computer (902)) and responding to the received requests by processing the said requests in an appropriate software application. In addition, requests may also be sent to the computer (902) from internal users (for example, from a command console or by other appropriate access method), external or third-parties, other automated applications, as well as any other appropriate entities, individuals, systems, or computers.

Each of the components of the computer (902) can communicate using a system bus (903). In some implementations, any or all of the components of the computer (902), both hardware or software (or a combination of hardware and software), may interface with each other or the interface (904) (or a combination of both) over the system bus (903) using an application programming interface (API) (912) or a service layer (913) (or a combination of the API (912) and service layer (913). The API (912) may include specifications for routines, data structures, and object classes. The API (912) may be either computer-language independent or dependent and refer to a complete interface, a single function, or even a set of APIs. The service layer (913) provides software services to the computer (902) or other components (whether or not illustrated) that are communicably coupled to the computer (902). The functionality of the computer (902) may be accessible for all service consumers using this service layer. Software services, such as those provided by the service layer (913), provide reusable, defined business functionalities through a defined interface. For example, the interface may be software written in JAVA, C++, or other suitable language providing data in extensible markup language (XML) format or other suitable format. While illustrated as an integrated component of the computer (902), alternative implementations may illustrate the API (912) or the service layer (913) as stand-alone components in relation to other components of the computer (902) or other components (whether or not illustrated) that are communicably coupled to the computer (902). Moreover, any or all parts of the API (912) or the service layer (913) may be implemented as child or sub-modules of another software module, enterprise application, or hardware module without departing from the scope of this disclosure.

The computer (902) includes an interface (904). Although illustrated as a single interface (904) in FIG. 9, two or more interfaces (904) may be used according to particular needs, desires, or particular implementations of the computer (902). The interface (904) is used by the computer (902) for communicating with other systems in a distributed environment that are connected to the network (930). Generally, the interface (904) includes logic encoded in software or hardware (or a combination of software and hardware) and operable to communicate with the network (930). More specifically, the interface (904) may include software supporting one or more communication protocols associated with communications such that the network (930) or interface's hardware is operable to communicate physical signals within and outside of the illustrated computer (902).

The computer (902) includes at least one computer processor (905). Although illustrated as a single computer processor (905) in FIG. 9, two or more processors may be used according to particular needs, desires, or particular implementations of the computer (902). Generally, the computer processor (905) executes instructions (e.g., program code) and manipulates data to perform the operations of the computer (902) and any algorithms, methods, functions, processes, flows, and procedures as described in the instant disclosure.

The computer (902) also includes a memory (906) that holds data for the computer (902) or other components (or a combination of both) that can be connected to the network (930). For example, memory (906) can be a database storing data consistent with this disclosure. Although illustrated as a single memory (906) in FIG. 9, two or more memories may be used according to particular needs, desires, or particular implementations of the computer (902) and the described functionality. While memory (906) is illustrated as an integral component of the computer (902), in alternative implementations, memory (906) can be external to the computer (902).

The application (907) is an algorithmic software engine providing functionality according to particular needs, desires, or particular implementations of the computer (902), particularly with respect to functionality described in this disclosure. For example, application (907) can serve as one or more components, modules, applications, etc. Further, although illustrated as a single application (907), the application (907) may be implemented as multiple applications (907) on the computer (902). In addition, although illustrated as integral to the computer (902), in alternative implementations, the application (907) can be external to the computer (902).

There may be any number of computers (902) associated with, or external to, a computer system containing computer (902), each computer (902) communicating over network (930). Further, the term “client,” “user,” and other appropriate terminology may be used interchangeably as appropriate without departing from the scope of this disclosure. Moreover, this disclosure contemplates that many users may use one computer (902), or that one user may use multiple computers (902).

In some embodiments, the computer (902) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

One or more of the embodiments of the disclosure may have one or more of the following advantages: improvement to the technical field of energy supply systems by enabling a battery storage to power a drilling rig without any online generators; reduce the impact to operations if generators fail or a fault is predicted, making the overall power system more resilient; protect critical equipment (e.g., fuel pumps, air compressors, rectifiers) from tripping offline and having to be manually reset with improved control scheme of the active front end; subsequent improvement to generator and equipment efficiency and lifespan due to reduction of unplanned shutdowns.

Although the disclosure has been described with respect to a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A method of operating an energy supply system of a drilling rig, the energy supply system including a battery storage, a generator, and an electrical bus that connects to the drilling rig, the method comprising:
providing power to the electrical bus with the generator or a utility grid, wherein the electrical bus is energized with a bus voltage at a bus frequency;
monitoring the electrical bus for a predetermined condition; and
controlling an active front end (AFE) connected to the battery storage based on whether or not the predetermined condition is satisfied, such that:
a first set of parameters is used by the AFE while the predetermined condition is not satisfied; and
a second set of parameters is used by the AFE while the predetermined condition is satisfied;
wherein, in response to detecting the predetermined condition while monitoring the electrical bus, the energy supply system forms a microgrid that powers the drilling rig with only the battery storage, wherein the AFE regulates the microgrid using the second set of parameters,
wherein, in response to detecting the predetermined condition not being satisfied while monitoring the electrical bus, the energy supply system powers the drilling rig with the generator or the utility grid, wherein the AFE regulates the battery storage using the first set of parameters,
wherein the second set of parameters is based on a droop speed control scheme.

2. The method of claim 1,
wherein the predetermined condition includes at least one of:
a breaker, that is configured to connect the generator to the electrical bus, being in a disconnected state;
a fault detected in a subsystem of the generator; and
the bus frequency of the electrical bus being outside a predetermined range.

3. The method of claim 1,
wherein the first set of parameters and the second set of parameters include different set points for a proportional integral (PI) controller of the AFE, and
wherein the second set of parameters includes PI controller set points for a frequency droop gradient and a voltage droop gradient of the microgrid.

4. The method of claim 1,
wherein the first set of parameters and the second set of parameters include different set points for a proportional integral (PI) controller of the AFE, and
wherein the second set of parameters includes PI controller set points for a frequency droop smoothing time and a voltage droop smoothing time of the microgrid.

5. The method of claim 2, further including:
monitoring a filter subsystem of the generator;
in response to detecting a fault in the filter subsystem, the energy supply system:
determines that the predetermined condition is satisfied;
disconnects the breaker;
forms the microgrid; and
switches to the second set of parameters to regulate the microgrid; and
in response to not detecting the fault in the filter subsystem, the energy supply system controls the AFE based on the first set of parameters.

6. The method of claim 2, further including:
monitoring a fuel pump subsystem that supplies the generator;
in response to detecting a fault in the fuel pump subsystem, the energy supply system:
determines that the predetermined condition is satisfied;
disconnects the breaker;
forms the microgrid; and
switches to the second set of parameters to regulate the microgrid; and
in response to not detecting the fault in the fuel pump subsystem, the energy supply system controls the AFE based on the first set of parameters.

7. The method of claim 1, further including:
transmitting, in response to switching to the second set of parameters, a start command to a secondary generator.

8. The method of claim 7, further including:
transmitting, in response to switching to the second set of parameters, a command to the drilling rig that limits operation of a mud pump, a top drive, or a drawworks on the drilling rig until the secondary generator is connected to the electrical bus.

9. An energy supply system for operating a drilling rig, the energy supply system comprising:
an electrical bus that powers the drilling rig;
a battery storage configured to draw power from and supply power to the electrical bus;
a generator or a utility grid interface configured to supply power to the electrical bus with a bus voltage at a bus frequency; and
a processor configured to:
monitor the electrical bus for a predetermined condition; and
control an active front end (AFE) connected to the battery storage based on whether or not the predetermined condition is satisfied, such that:
a first set of parameters is used by the AFE while the predetermined condition is not satisfied; and
a second set of parameters is used by the AFE while the predetermined condition is satisfied,
wherein, in response to detecting the predetermined condition while monitoring the electrical bus, the processor is configured to form a microgrid that powers the drilling rig with only the battery storage via the AFE, wherein the AFE regulates the microgrid using the second set of parameters,
wherein, in response to detecting the predetermined condition not being satisfied while monitoring the electrical bus, the processor is configured to control powering of the drilling rig with the generator or the utility grid interface, wherein the AFE regulates the battery storage using the first set of parameters, and
wherein the second set of parameters is based on a droop speed control scheme.

10. The energy supply system of claim 9,
wherein the predetermined condition includes at least one of:
a breaker, that is configured to connect the generator to the electrical bus, being in a disconnected state;
a fault detected in a subsystem of the generator; and
the bus frequency of the electrical bus exceeding a predetermined range.

11. The energy supply system of claim 9,
wherein the first set of parameters and the second set of parameters include different set points for a proportional integral (PI) controller of the AFE, and
wherein the second set of parameters includes PI controller set points for a frequency droop gradient and a voltage droop gradient of the microgrid.

12. The energy supply system of claim 9,
wherein the first set of parameters and the second set of parameters include different set points for a proportional integral (PI) controller of the AFE, and
wherein the second set of parameters includes PI controller set points for a frequency droop smoothing time and a voltage droop smoothing time of the microgrid.

13. The energy supply system of claim 10, wherein the processor is further configured to:
monitor a filter subsystem of the generator;
in response to detecting a fault in the filter subsystem, the processor is configured to:
determine that the predetermined condition is satisfied;
disconnect the breaker;
form the microgrid; and
switch to the second set of parameters to regulate the microgrid; and
in response to not detecting the fault in the filter subsystem, the processor is configured to control the AFE based on the first set of parameters.

14. The energy supply system of claim 10, wherein the processor is further configured to:
monitor a fuel pump subsystem that supplies the generator;
in response to detecting a fault in the fuel pump subsystem, the processor is configured to:
determines that the predetermined condition is satisfied;
disconnect the breaker;
form the microgrid; and
switch to the second set of parameters to regulate the microgrid; and
in response to not detecting the fault in the fuel pump subsystem, the processor is configured to control the AFE based on the first set of parameters.

15. The energy supply system of claim 9, wherein the processor is further configured to:
transmit, in response to switching to the second set of parameters, a start command to a secondary generator.

16. The energy supply system of claim 15, wherein the processor is further configured to:
transmit, in response to switching to the second set of parameters, a command to the drilling rig that limits operation of a mud pump, a top drive, or a drawworks on the drilling rig until the secondary generator is connected to the electrical bus.

17. A non-transitory computer readable medium (CRM) storing computer readable program code for operating an energy supply system of a drilling rig, the energy supply system including a battery storage, a generator, and an electrical bus that connects to the drilling rig, wherein the computer readable program code causes a computer system to:
provide power to the electrical bus with the generator or a utility grid, wherein the electrical bus is energized with a bus voltage at a bus frequency;
monitor the electrical bus for a predetermined condition; and
control an active front end (AFE) connected to the battery storage based on whether or not the predetermined condition is satisfied, such that:
a first set of parameters is used by the AFE while the predetermined condition is not satisfied; and
a second set of parameters is used by the AFE while the predetermined condition is satisfied;
wherein, in response to detecting the predetermined condition while monitoring the electrical bus, the energy supply system forms a microgrid that powers the drilling rig with only the battery storage, wherein the AFE regulates the microgrid using the second set of parameters,
wherein, in response to detecting the predetermined condition not being satisfied while monitoring the electrical bus, the energy supply system powers the drilling rig with the generator or the utility grid, wherein the AFE regulates the battery storage using the first set of parameters,
wherein the second set of parameters is based on a droop speed control scheme.

18. The non-transitory computer readable medium of claim 17,
wherein the predetermined condition includes at least one of:
a breaker, that is configured to connect the generator to the electrical bus, being in a disconnected state;
a fault detected in a subsystem of the generator; and
the bus frequency of the electrical bus being outside a predetermined range.

19. The non-transitory computer readable medium of claim 17,
wherein the first set of parameters and the second set of parameters include different set points for a proportional integral (PI) controller of the AFE, and
wherein the second set of parameters includes PI controller set points for a frequency droop gradient and a voltage droop gradient of the microgrid.

20. The non-transitory computer readable medium of claim 17,
wherein the first set of parameters and the second set of parameters include different set points for a proportional integral (PI) controller of the AFE, and
wherein the second set of parameters includes PI controller set points for a frequency droop smoothing time and a voltage droop smoothing time of the microgrid.
